(19) United States
(12) Patent Application Publication
(10) Pub. No.: US 2020/0299573 A1
(43) Pub. Date: Sep. 24, 2020

(54) COMPOSITE COMPRISING SEMICONDUCTOR NANOCRYSTALS AND METHOD OF PREPARING THE SAME

(71) Applicant: Dow Global Technologies LLC, Midland, MI (US)

(72) Inventors: Bo Lv, Shanghai (CN); Xiuyan Wang, Shanghai (CN); Yan Huang, Shanghai (CN); Xiaofan Ren, Shanghai (CN); Jake Joo, Marlborough, MA (US); Ping Zhu, Shanghai (CN)

(21) Appl. No.: 16/086,108

(22) PCT Filed: Mar. 30, 2016
(86) PCT No.: PCT/CN2016/077827

§ 371 Date: Sep. 18, 2018

(51) Int. Cl. C09K 11/02; C09K 11/88; C09K 11/08; C08G 77/02; C08K 9/02; C08K 3/32

(52) U.S. Cl. CPC C09K 11/02; C09K 11/883; C09K 11/0883; B82Y 20/00; C08K 9/02; C08K 3/32; C08K 2201/011; C08G 77/02

(57) ABSTRACT

A method of preparing a semiconductor nanocrystal-silicate composite without significantly reducing the quantum yield of the semiconductor nanocrystal, a composite prepared from the method, and a film and an electronic device comprising the composite.

### FIELD OF THE INVENTION

The present invention relates to a composite comprising semiconductor nanocrystals and a method of preparing the same.

### INTRODUCTION

Liquid crystal displays (LCDs) are used in a wide range of display applications. Traditional LCD white backlight is produced from blue light emitting diodes (LEDs) and yellow phosphor. The RGB (red, green, blue) color set is generated via corresponding color filters. Light absorption limitation of color filters leads to low color purity in green and red pixels; therefore LCD displays still have room for improvement at color gamut. Recently, semiconductor nanocrystals such as Quantum Dots (QDs) coupled with blue backlight has emerged as a new backlight source. As photo-emitters, QDs have many advantages, such as high emission intensity, broad and strong absorption and narrow emission bands. However, QDs are sensitive to oxygen, moisture and their chemical surroundings, which complicates the handling and storage of QDs and demands the use of encapsulation films when incorporating QDs to the LCD backlight.

The sensitivity of QD also restricts its exploitation in other applications which otherwise would benefit from its photoluminescent properties. When using QDs in LEDs as down conversion materials, oxygen may migrate through the LED encapsulant to the surface of QDs, which can lead to photo-oxidation and, as a result, a drop in quantum yield (QY).

To overcome this problem, various methods have been developed to incorporate semiconductor nanocrystals such as QDs into microsized or nanosized matrices in the form of resins, monoliths, glasses, sol gels or other host materials. Unfortunately, most of the approaches investigated require processing steps of exposing QDs to environments that contain acid, base, free radicals, or harmful chemicals, which can be damaging to the integrity and/or optical performance of the QDs. Recently, reports have been published describing encapsulation methods that provide QD-silica composites maintaining >80% of the initial QYs of the QDs. For example, by addition of additives and post photo treatment, the use of reverse microemulsion can provide silica-coated CdS-type QDs without significant drop of QY. The drawbacks of this method are that it may not be able to work for other QD types such as III-V type QDs, and that reverse microemulsion is not suitable for large scale production.

For another example, highly luminescent and photostable QD-silica monolith has been reported that was homogeneously doped with CdSe type QDs. Propylamine was used as the catalyst for silica sol gel condensation, and no adverse impact of this catalyst on the QD photoluminescence was observed during the sol gel process. However, for less robust and more sensitive QDs such as III-V type QDs, such process would result in a drastic QY drop.

Therefore, significant challenges remain to the development of an economically viable encapsulation method for semiconductor nanocrystals, particularly QDs. This method should also be applicable to different QD types such as III-V type QDs while maintaining >60% of the initial QYs of the QDs.

### SUMMARY OF THE INVENTION

The present invention provides a novel method of preparing a semiconductor nanocrystal-silicate composite, a composite obtained therefrom, a film and an electronic device comprising the composite.

In a first aspect, the present invention provides a method of preparing a semiconductor nanocrystal-silicate composite. The method comprises:

(i) providing a sol gel silicate solution, wherein the sol gel silicate is a reaction product of a first silane having the structure of Si(OR¹)₄, wherein R¹ is selected from a substituted or unsubstituted C₁-C₈ alkyl, or a substituted or unsubstituted C₁-C₈ heteroalkyl; and a second silane having the structure of R²SiR³ₙ(OR⁴)₃₋ₙ, wherein n is an integer selected from 0, 1 and 2; R² and R³ are each independently selected from hydrogen, a substituted or unsubstituted C₁-C₃₆ alkyl, a substituted or unsubstituted C₁-C₃₆ heteroalkyl, a substituted or unsubstituted alkenyl, a substituted or unsubstituted alkynyl, a substituted or unsubstituted alkoxy, a substituted or unsubstituted aromatic group, an aliphatic cyclic group, a heterocyclic group, or a heteroaromatic group; and R⁴ is selected from a substituted or unsubstituted C₁-C₈ alkyl, or a substituted or unsubstituted C₁-C₈ heteroalkyl; wherein the sol gel silicate has a number average molecular weight of 500 or more;

(ii) mixing semiconductor nanocrystals with the sol gel silicate solution to form a mixture;

(iii) drying or allowing to dry the mixture to provide the composite; and

(iv) optionally milling the composite.

In a second aspect, the present invention provides a semiconductor nanocrystal-silicate composite prepared by the method of the first aspect.

In a third aspect, the present invention provides a film comprising the composite of the second aspect.

In a fourth aspect, the present invention provides an electronic device comprising the composite of the second aspect.

### BRIEF DESCRIPTION OF THE DRAWINGS

FIG. 1 is QY retention for QD-Silicate 1 composite in polymethyl methacrylate (PMMA) films of Example 6 and QD-Silicate 3 composite in PMMA films of Example 7, as compared to that of Comp Ex A (all samples were left in open air).

### DETAILED DESCRIPTION OF THE INVENTION

An “electronic device” refers to a device which depends on the principles of electronics and uses the manipulation of electron flow for its operation.

An “alkyl” refers to an acyclic saturated monovalent hydrocarbon group and includes linear and branched groups with hydrogen unsubstituted or substituted by a halogen, a hydroxyl, a thiol, a cyano, a sulfo, a nitro, an alkyl, a perfluoroalkyl, or combinations thereof.

A “heteroalkyl” refers to a saturated hydrocarbon group having a linear or branched structure wherein one or more of the carbon atoms within the alkyl group has been replaced with a heteroatom or a heterofunctional group containing at least one heteroatom.

Heteroatoms may include, for example, O, N, P, S and the like. The heterofunctional group containing at least one heteroatom herein may include, for example, COOR′, OCOOR′, OR′, NR′₂, PR′₂, P(═O)R′₂, or SiR′₃; where each R′ is H, an unsubstituted or substituted C₁-C₃₀ alkyl group, or an unsubstituted or substituted C₆-C₃₀ aromatic group.

An “alkenyl” refers to an unsaturated hydrocarbon that contains at least one carbon-carbon double bond. A substituted alkenyl refers to an alkenyl wherein at least one of the hydrogens on the carbon double bond is replaced by an atom or group other than H. Similarly, an “alkynyl” refers to an unsaturated hydrocarbon containing at least one carbon-carbon triple bond. A substituted alkenyl refers to an alkenyl wherein at least one of the hydrogens on the carbon double bond is replaced by an atom or group other than H, for example, a C₁-C₃₀ alkyl group or C₆-C₃₀ aromatic group. In case that an alkenyl or alkynyl group contains more than one unsaturated bonds, these bonds usually are not cumulated, but may be arranged in an alternating order, such as in —[CH═CH—]ₓ, where x may be from the range of 2-50. Where not defined otherwise, preferred alkyl contains 1-22 carbon atoms; preferred alkenyl and alkynyl contain 2-22 carbon atoms.

An “alkoxy” refers to an alkyl group singular bonded with oxygen. Alkoxy such as C₁-C₂₄ alkoxy is a straight-chain or branched radical, for example, methoxy, ethoxy, isopropoxy, n-butoxy, sec-butoxy, tert-butoxy, heptyloxy, octyloxy, isooctyloxy, nonyloxy, decyloxy, undecyloxy, dodecyloxy, tetradecyloxy, hexadecyloxy, and octadecyloxy. A substituted alkoxy refers to a substituted alkyl group singular bonded with oxygen.

An “aliphatic cyclic group” refers to an organic group that is both aliphatic and cyclic. The aliphatic cyclic group contains one or more carbon rings that can be either saturated or unsaturated. A substituted aliphatic cyclic group may have one or more side chains attached, where the side chain can be a substituted or unsubstituted alkyl, a substituted or unsubstituted heteroalkyl, a substituted or unsubstituted alkenyl, a substituted or unsubstituted alkynyl, or a substituted or unsubstituted alkoxy. Examples of aliphatic cyclic groups include cyclobutyl, cyclopentyl, cyclohexyl, methylcyclohexyl, dimethylcyclohexyl, trimethylcyclohexyl, 1-adamantyl, and 2-adamantyl.

A “heterocyclic group” refers to a cyclic compound that has atoms of at least two different elements as members of its ring(s). A heterocyclic group usually contains 5 to 7 ring members, among them, at least 1, especially 1-3, heteromoieties, usually selected from O, S, NR′. Examples include C₄-C₁₈ cycloalkyl, which is interrupted by O, S, or NR′, such as piperidyl, tetrahydrofuranyl, piperazinyl, and morpholinyl. Unsaturated variants may be derived from these structures, by abstraction of a hydrogen atom on adjacent ring members with formation of a double bond between them; an example for such a moiety is cyclohexenyl. A substituted heterocyclic group may have one or more side chains attached, where the side chain can be a substituted or unsubstituted alkyl, a substituted or unsubstituted heteroalkyl, substituted or unsubstituted alkenyl, a substituted or unsubstituted alkynyl, a substituted or unsubstituted alkoxy, or another heterocyclic group either directed linked together or via linking groups.

An “aromatic group” refers to a hydrocarbon with sigma bonds and delocalized pi electrons between carbon atoms forming rings, usually the benzene-based, or aryl groups. Aryl is defined as an aromatic or polyaromatic substituent containing 1 to 4 aromatic rings (each ring containing 6 conjugated carbon atoms and no heteroatoms) that are optionally fused to each other or bonded to each other by carbon-carbon single bonds. A substituted aromatic or aryl group refers to an aryl ring with one or more substituents replacing the hydrogen atoms on the ring. The aryl group is unsubstituted or optionally and independently substituted by any synthetically accessible and chemically stable combination of substituents that are independently a halogen, a cyano, a sulfo, a carboxy, an alkyl, a perfluoroalkyl, an alkoxy, an alkylthio, an amino, a monoalkylamino, or a dialkylamino. Examples include substituted or unsubstituted derivatives of phenyl; biphenyl; o-, m-, or p-terphenyl; 1-naphthal; 2-naphthal; 1-, 2-, or 9-anthryl; 1-, 2-, 3-, 4-, or 9-phenanthrenyl and 1-, 2-, or 4-pyrenyl. Preferable aromatic or aryl groups are phenyl, substituted phenyl, naphthyl or substituted naphthyl.

A “heteroaromatic group”, or a “heteroaryl group” refers to a 5- or 6-membered heteroaromatic ring that is optionally fused to an additional 6-membered aromatic ring(s), or is optionally fused to a 5- or 6-membered heteroaromatic rings. The heteroaromatic rings contain at least 1 and as many as 3 heteroatoms that are selected from the group consisting of O, S or N in any combination. A substituted heteroaromatic or heteroaryl group refers to a heteroaromatic or heteroaryl ring with one or more substituents replacing the hydrogen atoms on the ring. The heteroaromatic or heteroaryl group is unsubstituted or optionally and independently substituted by any synthetically accessible and chemically stable combination of substituents that are independently H, a halogen, a cyano, a sulfo, a carboxy, an alkyl, a perfluoroalkyl, an alkoxy, an alkylthio, an amino, a monoalkylamino, or a dialkylamino.

Examples include substituted or unsubstituted derivatives of 2- or 3-furanyl; 2- or 3-thienyl; N-, 2- or 3-pyrroyl; 2- or 3-benzofuranyl; 2- or 3-benzothienyl; N-, 2-, or 3-indolyl; 2-, 3-, or 4-pyridyl; 2-, 3-, or 4-quinolyl; 1-, 3-, or 4-isoquinlyl; 2-benzoxazolyl; 2-, 4-, or 5-(1,3-oxazolyl); 2-, 4-, or 5-(1,3-thiazolyl); 2-benzothiazolyl; 3-, 4-, or 5-isoxazolyl; N-, 2-, or 4-imidazolyl; N-, or 2-benimidazolyl; 1-, or 2-naphthofuranyl; 1-, or 2-naphthothieyl; N-, 2- or 3-benzindolyl; or 2-, 3-, or 4-benzoquinolyl.

The “quantum yield” of a semiconductor nanocrystal is the ratio of the number of photons emitted to the number of photons absorbed.

A “semiconductor nanocrystal” is a tiny crystalline particle that has a typical dimension in the range of 1-100 nanometers (nm), and exhibits size-dependent optical and electronic properties. It displays discrete electronic transitions reminiscent of isolated atoms and molecules.

A “quantum dot” is a colloidal semiconductor nanocrystal with a typical dimension of less than 20 nm, or more typically 10 nm. The size of a semiconductor nanocrystal determines its electronic properties, with the band gap energy being inversely proportional to its size due to quantum confinement effects. Different sized QDs may emit light of different wavelength when excited by a single wavelength of light.

An “excited state” is an electronic state of a molecule in which the electrons populate an energy state that is higher than another energy state for the molecule.

A “sol gel” process refers to a process in which solution or sol undergoes a sol gel transition. At this transition, the solution becomes a rigid non-fluid mass. A “sol gel silicate” is a material containing a network of Si—O—Si chemical linkages prepared by the sol gel polymerization under hydrolytic conditions.

The sol gel silicate useful in the present invention is a reaction product of one or more first silanes and one or more second silanes. The first silane useful in preparing the sol gel silicate has the structure of formula (I), Si(OR¹)₄, wherein R¹ is selected from a substituted or unsubstituted C₁-C₈ alkyl, a substituted or unsubstituted C₁-C₄ alkyl, or a substituted or unsubstituted C₁-C₂ alkyl; or a substituted or unsubstituted C₁-C₈ heteroalkyl, a substituted or unsubstituted C₁-C₄ heteroalkyl, or a substituted or unsubstituted C₁-C₂ heteroalkyl.

Examples of suitable first silanes include tetramethoxysilane (TMOS), tetraethoxysilane (TEOS), tetra-n-propoxysilane, tetra-n-butoxysilane, tetrapentyloxysilane, tetrahexyloxysilane, tetrakis(methoxyethoxy)silane, tetrakis(ethoxyethoxy)silane, tetrakis(methoxyethoxyethoxy)silane, tetrakis(methoxypropoxy)silane, tetrakis(2-methyl-hexoxy)silane, tetra-C₂-C₄ alkenyloxysilanes such as tetraallyloxysilane, or mixtures thereof. The first silane is preferably TEOS, TMOS, or a mixture thereof.

The second silane useful in preparing the sol gel silicate has the structure of formula (II), R²SiR³ₙ(OR⁴)₃₋ₙ,

wherein n is an integer selected from 0, 1 and 2;

R² and R³ are each independently selected from hydrogen, a substituted or unsubstituted C₁-C₃₆ alkyl, a substituted or unsubstituted C₁-C₁₈ alkyl, or a substituted or unsubstituted C₁-C₁₂ alkyl; a substituted or unsubstituted C₁-C₃₆ heteroalkyl, a substituted or unsubstituted C₁-C₈ heteroalkyl, or a substituted or unsubstituted C₁-C₁₂ heteroalkyl; a substituted or unsubstituted alkenyl, for example, a substituted or unsubstituted C₂-C₂₄ alkenyl, a substituted or unsubstituted C₂-C₁₈ alkenyl, or a substituted or unsubstituted C₂-C₁₂ alkenyl; a substituted or unsubstituted alkynyl, for example, a substituted or unsubstituted C₂-C₂₄ alkynyl, a substituted or unsubstituted C₂-C₁₈ alkynyl, or a substituted or unsubstituted C₂-C₁₂ alkynyl; a substituted or unsubstituted alkoxy, for example, a substituted or unsubstituted C₁-C₂₄ alkoxy, a substituted or unsubstituted C₁-C₁₈ alkoxy, or a substituted or unsubstituted C₁-C₁₂ alkoxy, such as methoxy, ethoxy, isopropoxy, n-butoxy, sec-butoxy, tert-butoxy, heptyloxy, octyloxy, isooctyloxy; a substituted or unsubstituted aromatic group, for example, a substituted or unsubstituted C₆-C₂₄ aromatic group, a substituted or unsubstituted C₆-C₁₈ aromatic group, or a substituted or unsubstituted C₆-C₁₂ aromatic group, such as phenyl, 1-naphenyl, 2-naphthal, biphenyl, o-, m-, or p-terphenyl, 1-, 2-, or 9-anthryl, 1-, 2-, 3-, 4-, or 9-phenanthrenyl and 1-, 2-, or 4-pyrenyl; an aliphatic cyclic group, for example, cyclobutyl, cyclopentyl, cyclohexyl, methylcyclohexyl, dimethylcyclohexyl, trimethylcyclohexyl, 1-adamantyl, and 2-adamantyl; a heterocyclic group containing, for example, piperidyl, tetrahydrofuranyl, piperazinyl, and morpholinyl; a heteroaromatic group, for example, substituted or unsubstituted derivatives of 2- or 3-furanyl; 2- or 3-thienyl; N-, 2- or 3-pyrroyl; 2- or 3-benzofuranyl; 2- or 3-benzothienyl; and R⁴ is selected from a substituted or unsubstituted C₁-C₈ alkyl, a substituted or unsubstituted C₁-C₄ alkyl, or a substituted or unsubstituted C₁-C₂ alkyl; or a substituted or unsubstituted C₁-C₈ heteroalkyl, a substituted or unsubstituted C₁-C₄ heteroalkyl, or a substituted or unsubstituted C₁-C₂ heteroalkyl. The heteroalkyl in the present invention may be a heteroalkyl with functional groups selected from a carboxylic group, an ester group, a carbonyl group, an aldehyde group, an ether group, a mercapto group, an amino group, a phosphine group, a phosphine oxide group, an amide group, or a mixture thereof.

Preferably, in formula (II), n is 0 and R² is selected from phenyl, naphenyl, a C₁-C₁₈ alkyl, or a C₁-C₈ heteroalkyl with functional groups selected from a carboxylic group, an ester group, an ether group, a mercapto group, or an amino group. Preferably, R⁴ is a C₁-C₂ alkyl.

In one embodiment, the second silane useful in preparing the sol gel silicate is a mixture of one compound having the structure of formula (II), wherein n is 0 and R² is selected from an alkyl or an aromatic group; and another compound having the structure of formula (II), wherein n is 0 and R² is a heteroalkyl with functional groups selected from a carboxylic group, an ester group, an ether group, a mercapto group, or an amino group.

Examples of suitable second silanes include methyltrimethoxysilane, ethyltrimethoxysilane, hexyltrimethoxysilane, 1-naphthyltrimethoxysilane, phenyltrimethoxysilane, 3-mercaptopropyltrimethoxysilane, 3-aminopropyltrimethoxysilane, cyclohexyltrimethoxysilane, 3-glycidyloxypropyltrimethoxysilane, octadecyltrimethoxysilane, undecyltrimethoxysilane, ethenyltrimethoxysilane, triethoxyvinylsilane, [2-(3,4-epoxycyclohexyl)ethyl]trimethoxysilane, 3-(2,3-epoxypropoxy)propyltrimethoxysilane, (3-glycidyloxypropyl)methyldiethoxysilane, 3-(2,3-epoxypropyloxy)propyltriethoxysilane, trimethoxy(4-vinylphenyl)silane, 3-[dimethoxy(methyl)silyl]propyl methacrylate, 3-(methacryloyloxy)propyl]trimethoxysilane, 3-[diethoxy(methyl)silyl]propyl Methacrylate, 3-(triethoxysilyl)propyl methacrylate, (3-acryloyloxypropyl)trimethoxysilane, 3-(2-aminoethylamino)propylmethyldimethoxysilane, n-(2-aminoethyl)-3-(trimethoxysilyl)propylamine, 3-aminopropyltrimethoxysilane, (3-anilinopropyl)trimethoxysilane, n-[2-(n-vinylbenzylamino)ethyl]-3-aminopropyltrimethoxysilane, n-(triethoxysilylpropyl)urea, dimethoxy-(3-mercaptopropyl)methylsilane, (3-mercaptopropyl)trimethoxysilane, (3-isocyanatopropyl)triethoxysilane, 11-(aminooxy)undecyltrimethoxysilane, 11-(2-methoxyethoxy)undecyltrimethoxysilane, or mixtures thereof.

The sol gel silicate useful in the present invention may further contain a moiety including a —O-M-O— bond, wherein M is selected from Al, Ti, Zr, and combinations thereof. Such sol gel silicate may be obtained by reacting one or more precursor compounds with the first and second silanes. Examples of suitable precursor compounds include tri-C₁-C₄ alkoxy aluminate like tri-n-, -i-propoxy aluminate, tri-n-butoxyaluminate, like di-C₁-C₄ alkoxy aluminoxy tri-C₁-C₄ alkoxy silanes such as dibutoxy-aluminoxy-triethoxy-silane; tetra-n-butoxy zirconate, tetraethoxy zirconate, and tetra-n-, -i-propoxy zirconate; tetra-C₁-C₄ alkoxy zirconate such as tetra-n-butyl titanate, tetraethoxy titanate, tetramethoxy titanate, and tetra-n-, -i-propoxy titanate; or mixtures thereof.

The sol gel silicate useful in the present invention may be obtained by reacting the first silane, the second silane, and optionally the precursor compound useful for generating the —O-M-O— bond, using conditions for sol gel reaction known to a person skilled in the chemistry art. The sol gel reaction may be conducted in the presence of a catalyst, preferably an acid or a base, and certain amount of water, for a period of time. The time duration for the sol gel reaction may vary from several months to a few minutes (min) depending on the catalyst, the reaction temperature and the first and second silanes used, for example, from several days to 30 min, or from 24 hours to 2 hours. Temperatures for the sol gel reaction may range from 0° C. to 600° C., from 10° C. to 200° C., or from 20° C. to 150° C. Suitable catalysts for the sol gel reaction may be selected from HF, HCl, HNO₃, H₂SO₄, HOAc, HCOOH, p-toluenesulfonic acid, NH₄OH, ethylamine, diethylamine, propylamine, dipropylamine, octylamine, or mixtures thereof. Preferred catalyst is HOAc, H₂SO₄, HCl, or a mixture thereof. The sol gel reaction can be carried out in the presence of a solvent. Preferred solvents are organic solvents. Examples of suitable solvents include propylene glycol methyl ether acetate (PGMEA), methanol, ethanol, n-propylanol, isopropylanol, butanol, pentylanol, hexanol, 2-ethoxyethanol, formamide, N, N-dimethylformamide, N, N-dimethylacetamide, dioxane, tetrahydrofuran, toluene, xylene, chloroform, ethyl acetate, acetone, a mixture of PGMEA and butanol, a mixture of toluene and butanol, a mixture of xylene and butanol, a mixture of chloroform and butanol, and the like. The first and second silanes undergo hydrolysis and condensation polymerization to result in the sol gel silicate or sol gel silicate solution. The molar ratio of total first silanes to total second silanes may be from 95/5 to 5/95, from 90/10 to 30/70, or from 90/10 to 50/50.

The sol gel silicate useful in the present invention may have a number average molecular weight of 500 or more, from 500 to 10,000, from 600 to 7,000, from 800 to 5,000, or from 1,000 to 3,000. The number average molecular weight may be measured using standard Gel Permeation Chromatography (GPC) with polystyrene standard.

The sol gel silicate solution useful in the present invention may have a solid content from 1% to 90% by weight, from 2% to 50% by weight, or from 4% to 30% by weight. The solid content may be measured after annealing the sol gel silicate solution at 110° C. in a vacuum oven for a period of time so that all solvent is removed.

Semiconductor nanocrystals useful in the present invention may include a group II-VI compound, a group III-V compound, a group I—III-VI compound, a group IV-VI compound, or combinations thereof, wherein the term “group” refers to a group in the Periodic Table of the Elements. The group II-VI compound may include a binary compound selected from CdSe, CdTe, ZnS, ZnSe, ZnTe, ZnO, HgS, HgSe, HgTe, MgSe, MgS, or mixtures thereof; a ternary compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, or mixtures thereof; a quaternary compound selected from HgZnTeS, CdZnSeS, CdZnSeTe, CdZnSTe, CdHgSeS, CdHgSeTe, CdHgSTe, HgZnSeS, HgZnSeTe, HgZnSTe, or mixtures thereof. The group III-V compound may include GaN, GaP, GaAs, GaSb, AlN, AlP, AIAs, AISb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, or mixtures thereof. A group I-III-VI compound may include CuInS₂, CuInSe₂, CuGaSe₂, AgInS₂, AgInSe₂, AgGaS₂, AgGaSe₂, or mixtures thereof. The Group V-VI compound may include SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, SnPbSTe, or mixtures thereof. The semiconductor nanocrystals can further include II-VI, III-V, I—III-V, and IV-VI compound, selected from materials described above, doped with one or more elements. The dopant elements can be selected from Mn, Ag, Eu, S, P, Cu, Ce, Tb, Au, Pb, Tb, Sb, Sn or Ti. Examples of doped semiconductor nanocrystals are ZnSe:Mn, ZnS:Mn, ZnSe:Cu and ZnS:Cu.

The semiconductor nanocrystals useful in the present invention may have a core/shell structure in which a first semiconductor nanocrystal is surrounded by a second semiconductor nanocrystal. Examples of shell materials include ZnS, ZnSe, MgS, MgSe, AlP, GaP, and oxides such as ZnO, Fe₂O₃, SiO₂, or mixtures thereof. In addition, the semiconductor nanocrystals may have a structure comprising a semiconductor nanocrystal core and multi-layer shell surrounding the core. The multi-layer shell may have two or more than two layered shell structure. The core-shell semiconductor nanocrystal preferably has a core size of less than 20 nm, less than 15 nm, or in the range of 2-5 nm. The semiconductor nanocrystals useful in the present invention may have a particle size of 1 nm to 100 nm, from 1 nm to 20 nm, or from 1 nm to 10 nm. The particle size of the semiconductor nanocrystals may be measured by transmission electron microscopy (TEM).

The surface of the semiconductor nanocrystals may be further treated by passivating the surface atoms with organic groups. This organic layer (capping ligands) helps to passivate surface traps, prevent particle-particle aggregation, stabilize the nanocrystals in different organic solvents, and protect the semiconductor nanocrystals from their surrounding electronic and chemical environment. In most cases, the capping ligands are the solvents used for nanocrystal preparation, and consist of a Lewis base compound, or a Lewis acid compound.

Examples of capping ligands include long chain fatty acids (e.g., myristic acid, stearic acid), phosphines (e.g., trioctylphosphine, t-butylphosphine), phosphine oxide (e.g., trioctylphosphine oxide, triphenylphosphine oxide), alkyl amines (e.g., hexadecylamine, octylamine), thiols (e.g., undecanylthiol, dodecanethiol), pyridine, and alkylphosphonic acid, or mixtures thereof. These capping ligands may also provide additional functional groups that may be used as linkage to other inorganic, organic or biological materials.

One factor that may limit the use of the semiconductor nanocrystal is its incompatibility with polar or aqueous media due to the non-polar surface capping ligands usually consisting of long alkyl chains. The most widely used procedure to modify the surface of semiconductor nanocrystals is known as ligand exchange. Lipophilic ligand molecules that coordinate onto the nanocrystal surface during the preparation reaction may subsequently be exchanged with one or more than one polar or charged ligands molecules. An alternative surface modification strategy is to interchelate polar or charged ligand molecules or polymer molecules with the ligand molecules that are already present on the nanocrystal surface. The ligand exchange procedure can also help introduce additional functional groups to the semiconductor nanocrystal surface.

The shape of the semiconductor nanocrystals may include a spherical, an oval, a cubic, a pyramidal, a multi-arm, a nanowire, a nanotube, a nanoplate, or the like.

The semiconductor nanocrystals may be synthesized according to the general method known in the art. Colloidal semiconductor nanocrystals, i.e., quantum dots, may be synthesized from precursor compounds dissolved in solutions, much like a traditional wet chemical processes. For example, the synthesis of quantum dots is done by using quantum dot precursors, organic surfactants, and solvents to form a solution, heating the solution at high temperature, decomposing the precursors, and forming monomers which then nucleate and generate nanocrystals.

The semiconductor nanocrystals useful in the present invention preferably emit light having a wavelength of approximately 400 to 900 nm, more preferably 400 to 700 nm. The semiconductor nanocrystals may have a quantum yield of 20% to 100%, 50% or more, 70% or more, or even 85% or more, according to the test methods described in Examples section below. In addition, the full width half maximum (FWHM) of the light emitting wavelength of the semiconductor nanocrystal may be selected to be narrower or wider depending on the application. It may have a narrower spectrum in order to improve the color purity or the color gamut in a display device. In this regard, the semiconductor nanocrystals may have a FWHM of light emitting wavelength of 60 nm or less, or 50 nm or less, or 40 nm or less.

The method for preparing a composite of the present invention may include encapsulating, or embedding, semiconductor nanocrystals in the sol gel silicate to form the composite, also called a semiconductor nanocrystal-silicate composite. The method comprises: (i) providing the sol gel silicate solution, (ii) mixing the semiconductor nanocrystals with the sol gel silicate to form a mixture, preferably in a solution form, (iii) drying or allowing the mixture to dry to form the composite, and (iv) optionally milling the composite. The mixture formed in step (ii) can contain one or more than one types of semiconductor nanocrystals. The mixture can also contain one or more than one types of sol gel silicates. The drying step (that is, step (iii) of the method of preparing the composite) can be conducted at a temperature ranging from 0° C. to 1,000° C., 25° C. to 300° C., 50° C. to 200° C., or 80° C. to 150° C. Time duration for the drying step may be in the range of from 1 min to several months, from 1 min to a few days, from 1 min to 24 hours, or from 10 min to 12 hours. The drying step can be conducted in open air or under inert atmosphere, under atmosphere pressure or preferably reduced pressure. Any types of containers may be used for the drying step. Preferred container types include glasses, polytetrafluoroethylene molders, and metal trays.

In the method of preparing the composite, prior to mixing with the semiconductor nanocrystals, the sol gel silicate solution may be treated to adjust its pH value ranging from 5 to 9, from 5 to 8, or from 6 to 8, to remove the catalyst used in the sol gel reaction. The pH adjustment methods are known to a person skilled in the chemistry art. Materials useful for pH value adjustment include, for example, an acid, a base, ion exchange resins such as weakly basic ion exchange resins, strongly basic ion exchange resins, weakly acidic ion exchange resins, and strongly acidic ion exchange resins. The removal of the catalyst used in the sol gel reaction when preparing the sol gel silicate would provide a sol gel silicate or a sol gel silicate solution with less adverse impact on the chemical and physical properties, or stability of a semiconductor nanocrystal, when the sol gel silicate and semiconductor nanocrystals are mixed together.

In the method of preparing the composite, prior to mixing with the sol gel silicate, the semiconductor nanocrystal may undergo a ligand exchange process, as described above, to improve its compatibility with the sol gel silicate or sol gel silicate solution. The useful ligand may comprise two types of functional groups, with one type of functional group able to coordinate to the surface of the semiconductor nanocrystal, and the other type of functional group able to promote compatibility with the sol gel silicate soundings. Examples of suitable ligands include 2-mercaptoethanol, 3-mercaptopropanol 4-mercaptobutanol, 5-mercaptopentanol, 6-mercaptohexanol, 7-mercaptoheptanol, 8-mercaptooctanol, 9-mercaptononanol, 10-mercaptodecanol, 11-mercapto-1-undecanol, 18-mercaptooctadecanol, 2-mercapto-acetic acid, 3-mercapto-propanoic acid, 4-mercaptobutanol, 5-mercaptopentanoic acid, 6-mercaptohexanoic acid, 7-mercaptoheptanoic acid, 8-mercaptooctanoic acid, 9-mercaptononanoic acid, 10-mercaptodecanoic acid, 11-mercapto-1-undecanoic acid, 18-mercaptooctadecanoic acid, 1-(3-mercaptopropyl)-silanetriol, 3-(trimethoxysilyl)-1-propanethiol, 6-(trimethoxysilyl)-1-hexanethiol, 10-(trimethoxysilyl)-1-decanethiol, 18-(trimethoxysilyl)-1-octadecanethiol, 6-amino-1-hexanethiol, 6-(trimethoxysilyl)-hexanoic acid, 7-(trimethoxysilyl)-heptanoic acid, 8-(trimethoxysilyl)-octanoic acid, 9-(trimethoxysilyl)-nonanoic acid, 10-(trimethoxysilyl)-decanoic acid, 11-(trimethoxysilyl)-1-undecanoic acid, 18-(trimethoxysilyl)-octadecanoic acid, or mixtures thereof.

In the method of preparing the composite, during the mixing of the sol gel silicate and semiconductor nanocrystals, one or more than one chemical or physical additives may be added to improve the final performance of the semiconductor nanocrystal-silicate composite. The additives can be compounds that would improve the compatibility between the semiconductor nanocrystals and sol gel silicate, such as polyhedral oligomeric silsesquioxane (POSS) derivatives, 6-mercaptohexanol, 10-mercaptodecanol, 11-mercapto-1-undecanol, or mixtures thereof. The additives can also be compounds that would protect the surface of the semiconductor nanocrystals so that the composite forming process would not affect the physical or chemical properties of the semiconductor nanocrystals, or limit the impact to a minimal level. The additives can further be compounds that would improve the stability, for example photostability, of the composite. The dosage of the additives may be in an amount of from 0 to 10% by weight, from 0 to 8% by weight, or from 0.01% to 5% by weight, based on the weight of the composite.

The semiconductor nanocrystal-silicate composite of the present invention may include 0.01% to 50% by weight of the semiconductor nanocrystals, from 0.1% to 25% by weight, or from 0.1% to 10% by weight, based on the total weight of the composite. The weight percentage would be such that the sol gel silicate can effectively surround and protect the semiconductor nanocrystal, and thus increase stability of the semiconductor nanocrystal. For example, the composite has better storage stability than the semiconductor nanocrystal, which can be indicated by higher QY retention after stored in open air for the same period of time according to the test method described in the Examples below. The weight percentage may also be adjusted depending on application fields.

The method of preparing the composite of the present invention leads to an improvement of the stability of the semiconductor nanocrystal including stabilities towards oxygen, moisture, and harmful chemicals such as acid, base, and free radicals, while maintaining its other properties. Preferably, the obtained semiconductor nanocrystal-silicate composite maintains >60% of the initial QY of the semiconductor nanocrystal, 70% or higher of the initial QY, or even 80% or higher of the initial QY. The method is also applicable for different types of semiconductor crystals, for example, III-V type QDs.

The resulted semiconductor nanocrystal-silicate composite obtained from step (iii) of the method of the present invention may be grounded to provide microsized or nanosized semiconductor nanocrystal-silicate composite. The grinding method and grinding device may be selected by a person skilled in the art. The grinding device can be simply a mortar and pestle, or an automatic mortar grinder. Grinding time, temperature and pressure can be adjusted depending on the sol gel silicate composition and targeted composite size. The grinding can be conducted in open air or under inert atmosphere. While not wishing to be bound by theory, it is believed that the largely inorganic nature of the semiconductor nanocrystal-silicate composite would not require costly milling method, such as cryogenic milling, to achieve desired sizes. It would also help avoid contamination of the composite by chemicals or inorganic powders introduced during the cryogenic milling process.

The obtained microsized or nanosized semiconductor nanocrystal-silicate composite may have a particle size of less than or equal to 200 micrometers, less than or equal to 100 micrometers, less than or equal to 50 micrometers, or less than or equal to 20 micrometers.

The size of the microsized or nanosized composite may be determined by scanning transmission electron microscopy (SEM). The microsized or nanosized composite may be further sieved through a sieve to remove undesired large-sized particles. The sieve may have a mesh size of less than or equal to 50 micrometers, less than or equal to 20 micrometers, or less than or equal to 10 micrometers.

The semiconductor nanocrystal-silicate composite of the present invention, before or after grinding, may be further embedded in a host material to provide a color conversion element. The host material can be organic, inorganic or hybrid in nature. Preferably, the host material is transparent to ultraviolet (UV) and/or visible light, especially transparent in the entire range of 420-700 nm. In one embodiment, the host material may comprise one or more materials selected from, for example, polystyrene, polyacrylate acid, a polyacrylate acid salt, an acrylic polymer such as polyacrylate, polycarbonate, polyolefin, polyvinyl alcohol, polyvinyl chloride, polyurethane, polyamide, polyimide, polyester such as polyethylene naphthalate or polyethylene terephthalate, polyether, polyvinyl ester, polyvinyl halide, silicone polymer, an epoxy resin, alkyd, polyacrylonitril, polyvinyl acetal, cellulose acetate butyrate, a siloxane polymer such as polydimethylsiloxane, or mixtures thereof. In another embodiment, the host material may comprise an inorganic material selected from, for example, ceramics, glasses, polysilsesquioxane and silicates. Optionally, the host material may include additional materials with functions desired for targeted application fields, such as a luminescent material which may be semiconductor nanocrystals or other types of luminescent materials. Optionally, the host material may further comprise one or more than one additives. Examples of suitable additives include antioxidants, radical scavengers, inorganic filler particles, organic filler particles, or mixtures thereof. The dosage of these additives may be in an amount of from 0 to 10% by weight, from 0 to 8% by weight, or from 0.01% to 5% by weight, based on the weight of the composite.

The present invention also provides a film comprising the semiconductor nanocrystal-silicate composite and the host material described above, wherein the composite is dispersed in the host material.

The present invention also provides an electronic device comprising the semiconductor nanocrystal-silicate composite of the present invention. The electronic device of the present invention can be an organic electronic device or an inorganic electronic device. The electronic device may be selected from a liquid crystal display device, an organic light-emitting device, and an inorganic light-emitting device. The electronic device of the present invention may comprise a light emitting apparatus, wherein the light emitting apparatus comprises a layer comprising the semiconductor nanocrystal-silicate composite, optionally embedded in a host material as described above.

The present invention also provides a light emitting apparatus comprising a layer comprising the semiconductor nanocrystal-silicate composite of the present invention. The layer comprising the composite in the light emitting apparatus may be embedded in a film formed by one or more host materials described above. The light emitting apparatus may further comprise a barrier layer which substantially excludes the transport of water or oxygen molecules.

The present invention also provides a backlight unit for a display apparatus comprising the light emitting apparatus described above. In one embodiment, the display apparatus may further comprise liquid crystal material. In another embodiment, the display apparatus further comprises organic light emitting diode (OLED) materials. In further another embodiment, the display apparatus may further comprise a color filter material. Preferably, the display apparatus comprises a color filter array, liquid crystal, polarizing film, and a backlight unit, wherein the backlight unit comprises the layer of the semiconductor nanocrystal-silicate composite of the present invention.

### Examples

Some embodiments of the invention will now be described in the following Examples, wherein all parts and percentages are by weight unless otherwise specified. The following materials are used in the examples:

| Chemical Name | Specification or structure | CAS No. | Supplier |
|---|---|---|---|
| Tetraethyl silicate (TEOS) | | 78-10-4 | SCRC* |
| 1-Naphyltrimethoxysilane | | 18052-76-1 | Shanghai |
| (NaphTMS) | | | Zhuorui Chemicals |
| (3-Mercaptopropyl) | | 4420-74-0 | SCRC |
| trimethoxysilane (STMS) | | | |
| Phenyltrimethoxysilane (PhTMS) | | 2996-92-1 | TCI Chemicals |
| Octadecyltrimethoxysilane | | 3069-42-9 | TCI Chemicals |
| Acetic acid | | 64-19-7 | SCRC |
| 2-Acetoxy-1-methoxypropane | | 108-65-6 | Aladdin |
| (PGMEA) | | | |
| AMBERJET ™ 4200H resin | Ion exchange resin | — | The Dow Chemical |
| (AMBERJET is a trademark of | | | Company |
| The Dow Chemical Company) | | | |
| PLEXIGLAS 8N | Polymethyl methacrylate | 9011-14-7 | Evonik |
| | (PMMA) | | Degussa |
| Hydrochloric Acid | 35% by weight | 7647-01-1 | SCRC |
| DOWEX ™ MS77 (DOWEX is | Alkalescent anion | | The Dow Chemical |
| a trademark of The Dow | exchanger | | Company |
| Chemical Company) | | | |
| n-Butanol | | 71-36-3 | SCRC |
| Myristic acid | 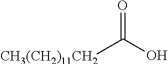 | 544-63-8 | Aldrich |
| Tris(trimethylsilyl)phosphine | 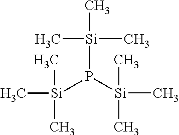 | 15573-38-3 | Strem Chemicals Inc. |
| 1-Octadecene | CH₃(CH₂)₁₅CH═CH₂ | 112-88-9 | Aldrich |
| zinc acetate | 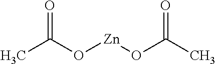 | 557-34-6 | Aldrich |
| Oleic acid | 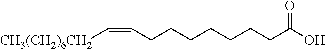 | 112-80-1 | Aldrich |
| Oleylamine | 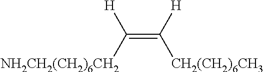 | 112-90-3 | Aldrich |
| tri-n-butylphosphine | 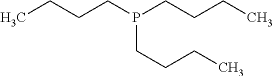 | 998-40-3 | Aldrich |
| Trioctylphosphine | 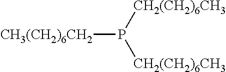 | 4731-53-7 | Aldrich |
| Trimethylindium | In(CH₃)₃ | 3385-78-2 | Shanghai HongRui |
| Sulfur | S | 7704-34-9 | SCRC |
| Selenium | Se | 7782-49-2 | Aldrich |

*SCRC refers to Sinopharm Chemical reagent Co., Ltd.

The following standard analytical equipment and methods are used in the Examples: GPC experiments (Agilent 1200 Iso pump with continuous vacuum degassing; Agilent refractive Index detector) were undertaken to measure molecular weights of sol gel silicates. Data were acquired and processed using Agilent Chemstation (Version B 02.01-SR1) and Agilent GPC-Addon software (Rev. B 01.01). Calibration curve were PL polystyrene Narrow standards (Part No 210-0101) with molecular weights ranging from 316,500 to 580 g/mol using polynom 3^{rd} fitness. Mobile phase solvent was tetrahydrofuran. Flow rate was 1.0 mL/min, and column temperature was 40° C.

PH value was tested by METTER TOLEDO SevenGo PH meter.

Solid contents of sol gel silicate solutions were measured by curing the solutions in a vacuum oven at 110° C. for 1.5 hours. After curing, the resulting silicate solid was weighted, which was divided by the initial solution weight to afford the solid content.

Scanning transmission electron microscopy (STEM, Nova™ NanoSEM 630) was employed to determine the particle size of semiconductor nanocrystal-silicate composites after grinding.

The solution absorption and emission spectra of QDs were characterized by UV-VIS-NIR spectrophotometer (SHIMADZU UV3600) and spectrofluorometer (HORIBA FluoroMax-4), respectively.

Solution quantum yields were recorded according to Standards for Photoluminescence Quantum Yield Measurements in Solution (IUPAC technical report, Pure Appl. Chem., 83 (12), 2213-2228, 2011). The reference systems were rhodamine 6G in ethanol (QY=95%) and 4,4-difluoro-1,3,5,7,8-pentyamethyl-4-bora-3a, 4a-diaza-s-indacene in ethanol (QY=99%).

Solid state quantum yields were measured by the Integrating Sphere (QUANTA-PHI) of spectrofluorometer (HORIBA FluoroMax-4).

Storage stability of samples was evaluated by QY retention after stored in open air for a certain number of days. Higher QY retention suggests better storage stability.

### Synthesis of InP/ZnSeS ODs

All the chemicals were degassed and stored in a glove box under argon (Ar). To a three-neck flask were added myristic acid (0.12 g, 0.52 mmol), zinc undecylenate (0.132 g, 0.36 mmol), and 7 mL of 1-octadecene (ODE). The reaction flask was then pumped and purged with Ar for three times and further heated to 310° C. with Ar over pressure. Trimethylindium (0.024 g, 0.15 mmol), oleylamine (0.1 mmol), and 2 mL of ODE were injected into the flask immediately. The resulting mixture was stirred at 270° C. for 6 min and then cooled down to room temperature. The flask was then transferred to a glove box.

Zinc acetate (0.069 g, 0.376 mmol) was added into the flask in a glove box. The mixture was stirred at 240° C. for 2.5 hours, and then temperature was set at 230° C. A TBPSe solution, prepared by dissolving Se (30 mg, 0.38 mmol) and tri-n-butylphosphine (200 μL) in 5 mL of ODE, was then added dropwise with vigorous stirring. After addition, the reaction mixture was kept at 230° C. for 10 min and then temperature was raised up to 280° C. 2 mL of TOPS solution prepared by dissolving 64 mg of sulfur in 2 mL of trioctylphosphine (TOP), and 4 mL of zinc oleate prepared by reacting 30 mmol of zinc acetate with 19 mL of oleic acid in 41 mL of ODE, were then added dropwise. The reaction was continued for another 20 min at 280° C. and then raised up to 300° C. At this temperature, TOPS solution (3 mL) and zinc oleate (6 mL) were added dropwise to form the additional shell. The resulting mixture was kept at 300° C. for 1 hour and then cooled down to room temperature rapidly. The as-prepared QD solution was transferred to the glove box. A non-solvent acetone was added and centrifugation was performed. The supernatant was discarded, and the precipitate was further dissolved in toluene, followed by addition of non-solvent ethanol and centrifugation. The toluene-ethanol process was repeated for two more times. The precipitate was finally dissolved in toluene to provide an InP/ZnSeS QD solution.

### Synthesis of Ligand Exchanged InP/ZnSeS QDs

Ligand Exchanged InP/ZnSeS QD(a)

In a glove box, 160 mg 6-mercaptohexan-1-ol together with 2.5 mL anhydrous ethanol and 2.5 mL anhydrous chloroform were added to a 25 mL glass bottle to form a homogeneous solution, followed by addition of 0.5 mL of InP/ZnSeS QD solution obtained above. The mixture was sonicated for 3 hours, followed by addition of hexane to precipitate the ligand exchanged QDs. After centrifugation, the obtained ligand exchanged QDs were dissolved in anhydrous ethanol.

Ligand Exchanged InP/ZnSeS QD(b)

In a glove box, 180 mg 11-mercapto-1-undercanol together with 2.5 mL of anhydrous ethanol and 2.5 mL of anhydrous chloroform were added to a 25 mL glass bottle to form a homogeneous solution, followed by addition of 0.5 mL InP/ZnSeS QD solution obtained above. The mixture was sonicated for 3 hours, followed by addition of hexane to precipitate the ligand exchanged QDs. After centrifugation, the obtained ligand exchanged QDs were dissolved in anhydrous ethanol.

### Example (Ex) 1

Preparation of Sol Gel Silicate 1 Solution

Tetraethoxysilane (TEOS, 56.16 g, 0.27 mol) and 1-Naphthalytrimethoxysilicate (NaphTMS, 7.44 g, 0.03 mol) were dissolved in PGMEA (200 mL). To this solution was added acetic acid/H₂O (3.96 g in 21 g) dropwise at room temperature. After full addition, the mixture was heated in a 100° C. oil bath with a Dean-Stark apparatus to distillate resulting alcohols out. After 5 hours reaction, the reaction mixture was cooled down. 100 mL of PGMEA was then added to quench the reaction. AMBERJET 42000H resin was used to neutralize the resulting solution to a pH ≥6. The obtained sol gel Silicate 1 solution was then stored at −20° C. for further use.

Preparation of QD-Silicate 1 Composite

1 mL of InP/ZnSeS QD solution obtained above was mixed with the sol gel Silicate-1 solution (8 g, 7% by weight solid content in PGMEA) at room temperature. The solution mixture was casted into a Polytetrafluoroethylene (PTFE) mold or an aluminum tray, and dried in a vacuum oven at 100° C. for 30 min to obtain QD-Silicate 1 composite. The emission property of the QD-Silicate 1 composite is compiled in Table 1.

### Ex 2

Preparation of Sol Gel Silicate 2(a) Solution

Tetraethoxysilane (TEOS, 21.84 g, 105 mmol), Naphalyltrimethoxysilicate (NapTMS, 5.58 g, 22.5 mmol), and 3-mercaptopropyl trimethylsilane (HS-TMS, 4.41 g, 22.5 mmol) were dissolved in PGMEA (100 mL). To this solution was added acetic acid/H₂O (1.88 g in 10 g) dropwise at room temperature. After full addition, the mixture was heated in a 100° C. oil bath with a Dean-Stark apparatus to distillate resulting alcohols out. After 5 hours reaction, the reaction system was cooled down. 50 mL of PGMEA was then added to quench the reaction. AMBERJET 42000H resin was used to neutralize the resulting solution to a pH ≥5. The obtained sol gel Silicate 2(a) solution was stored at −20° C. for further use.

Preparation of Sol Gel Silicate 2(b) Solution

The experimental procedure was substantially the same as in preparation of the sol gel Silicate 2(a) solution above, except that the solvent is PGMEA:butanol in a 1:1 volume ratio.

Preparation of Sol Gel Silicate 2(c) Solution

The experimental procedure was substantially the same as in preparation of the sol gel Silicate 2(a) solution above, except that the solvent is xylene:butanol in a 1:1 volume ratio.

Preparation of Sol Gel Silicate 2(d) Solution

The experimental procedure was substantially the same as in preparation of the sol gel Silicate 2(a) solution, except that the solvent is xylene:butanol in a 2:3 volume ratio.

### Ex 2(a) Preparation of QD-Silicate 2(a) Composite

1 mL of InP/ZnSeS QD solution obtained above was mixed with the sol gel Silicate 2(a) solution at room temperature. The solution mixture was casted into a PTFE mold or an aluminum tray, and dried in a vacuum oven at 100° C. for 30 min to obtain QD-Silicate 2(a) composite.

### Ex 2(b) Preparation of QD-Silicate 2(b) Composite

1 mL of InP/ZnSeS QD solution obtained above was mixed with the sol gel Silicate 2(b) solution at room temperature. The solution mixture was casted into a PTFE mold or an aluminum tray, and dried in a vacuum oven at 100° C. for 30 min to obtain QD-Silicate 2(b) composite. The emission property and QY retention of the obtained composite are compiled in Tables 2 and 3, respectively.

### Ex 2(b)-LE Preparation of Ligand Exchanged QD(a)-Silicate 2(b) Composite

1 mL of Ligand Exchanged InP/ZnSeS QD(a) solution obtained above was mixed with the sol gel Silicate 2(b) solution at room temperature. The solution mixture was casted into a PTFE mold or an aluminum tray, and dried in a vacuum oven at 100° C. for 30 min to obtain the Ligand Exchanged QD(a)-Silicate 2(b) composite. The emission property of the obtained composite is compiled in Table 2.

### Ex 2(c) Preparation of QD-Silicate 2(c) Composite

1 mL of InP/ZnSeS QD solution obtained above was mixed with the sol gel Silicate 2(c) solution at room temperature. The solution mixture was casted into a PTFE mold or an aluminum tray, and dried in a vacuum oven at 100° C. for 30 min to obtain QD-Silicate 2(c) composite.

### Ex 2(d) Preparation of QD-Silicate 2(d) Composite

1 mL of InP/ZnSeS QD solution obtained above was mixed with the sol gel Silicate 2(d) solution at room temperature. The solution mixture was casted into a PTFE mold or an aluminum tray, and dried in a vacuum oven at 100° C. for 30 min to obtain QD-Silicate 2(d) composite.

### Ex 3

Preparation of Sol Gel Silicate 3 Solution

TEOS (21.84 g, 105 mmol) and Phenyltrimethoxysilicate (PhTMS) (4.46 g, 22.5 mmol), and HS-TMS (4.41 g, 22.5 mmol) were dissolved in PGMEA (100 mL). To this solution was added acetic acid/H₂O (1.88 g in 10 g) dropwise at room temperature. After full addition, the mixture was heated in a 100° C. oil bath with a Dean-Stark apparatus to distillate resulting alcohols out. After 5 hours reaction, the reaction system was cooled down. AMBERJET 42000H resin was used to neutralize the resulting solution to a pH ≥5. The obtained sol gel Silicate 3 solution was stored at −20° C. for further use.

Preparation of QD-Silicate 3 Composite

1 mL of InP/ZnSeS QD solution obtained above was mixed with the sol gel Silicate 3 solution (8 g, 11% by weight solid content in PGMEA) at room temperature. The solution mixture was casted into a PTFE mold or an aluminum tray, and dried in a vacuum oven at 100° C. for 30 min to obtain QD-Silicate 3 composite. The emission property of the obtained composite is compiled in Table 1.

### Ex 4

Preparation of Sol Gel Silicate 4 Solution

n-C₁₈H₃₇Si(OMe)₃ (3.75 g, 0.01 mmol) and TEOS (6.24 g, 0.03 mmol) were dissolved in PGMEA (25 mL). To this solution was added AcOH/H₂O (0.50 g in 2.7 g) dropwise at room temperature. After full addition, the mixture was heated in a 105° C. oil bath with a Dean-Stark apparatus to distillate resulting alcohols out. After 4 hours reaction, the mixture was cooled down to room temperature. 50 mL of PGMEA was added. White solid was afforded after centrifugation. These solid was further dissolved in 100 mL of dry toluene. AMBERJET 42000H resin (4 g) was used to neutralize the sol gel silicate solution to a pH ≥6. The obtained sol gel Silicate 4 solution was stored at −20° C. for further use.

Preparation of QD-Silicate 4 Composite

1 mL of InP/ZnSeS QD solution obtained above was mixed with the sol gel Silicate 4 solution (5 g, 3% by weight solid content in PGMEA) at room temperature. The solution mixture was casted into a PTFE mold or an aluminum tray, and dried in a vacuum oven at 100° C. for 30 min to obtain QD-Silicate 4 composite.

### Ex 5

Preparation of Sol Gel Silicate 5 Solution

TEOS (20.8 g, 99.84 mmol) and HS-TMS (4.9 g, 24.96 mmol) were dissolved into n-butanol (17.5 g). To this solution, 1.25 g, 0.1M HCl and 6.2 g H₂O mixed together and then added dropwise at room temperature. After the full addition, the mixture was heated in a 70° C. oil bath. After 6-8 hours reaction, heating was stopped while stirring continued until the reaction system was cooled down. Then 17.5 g butanol was added to the reaction mixture. The resulting solution was filtered by alkalescent anion exchanger (DOWEX MS77) to remove HCl to afford a pH ≥6.

### Ex 5 (a) Preparation of QD-Silicate 5 Composite

1 mL of InP/ZnSeS QD solution was mixed with 5 g of the sol gel Silicate 5 solution (solid content: 6.7% by weight) at room temperature. The solution mixture was casted into a PTFE mold or an aluminum tray, and dried in a vacuum oven at 100° C. for 30 min to obtain the QD-Silicate 5 composite. The emission property of the obtained composite is compiled in Table 2.

### Ex 5 (b) Preparation of Ligand Exchanged QD(a)-Silicate 5 Composite

1 mL of Ligand Exchanged InP/ZnSeS QD(a) solution was mixed with 5 g of the sol gel Silicate 5 solution (solid content: 6.7% by weight) at room temperature. The solution mixture was casted into a PTFE mold or an aluminum tray, and dried in a vacuum oven at 100° C. for 30 min to obtain the Ligand Exchanged QD(a)-Silicate 5 composite. The emission property of the obtained composite is compiled in Table 2.

### Ex 6 Preparation of QD-Silicate 1 Composite PMMA Film

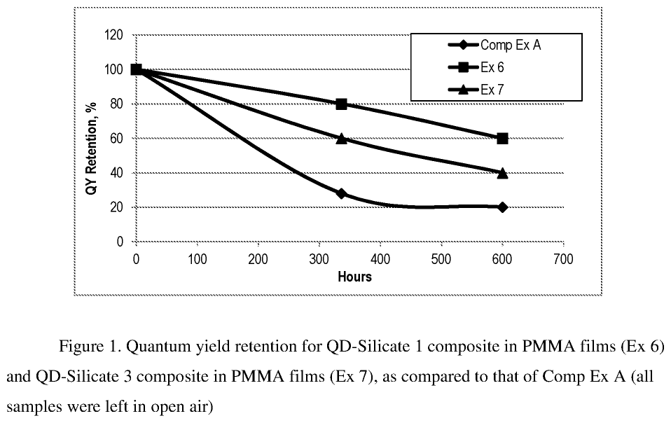

300 mg of the composite of Ex 1 was ground with a mortar and pestle at room temperature in the open air, till the size of the majority of the composite particles was reduced below 20 μm. It was then mixed with 3 g of PMMA solution (30% by weight in PGMEA) to form a homogeneous slurry, which was then coated on a Polyethylene terephthalate (PET) film via an automatic gap coat. The film was then dried in a vacuum oven at 60° C. for 3 hours to evaporate PGMEA solvent. The QY retention curve is compiled in FIG. 1.

### Ex 7 Preparation of QD-Silicate 3 Composite PMMA Film

300 mg of the composite of Ex 3 was ground with a mortar and pestle at room temperature in open air, till the size of the majority of the composite particles was reduced below 20 μm. It was then mixed with 3 g of PMMA solution (30% by weight in PGMEA) to form a homogeneous slurry, which was then coated on a PET film via an automatic gap coat. The film was then dried in a vacuum oven at 60° C. for 3 hours to evaporate PGMEA solvent. The QY retention curve is compiled in FIG. 1.

### Comparative (Comp) Ex A

1 mL of the InP/ZnSeS QD solution obtained above was mixed with 3 g PMMA solution (30% by weight in PGMEA) to form a homogeneous slurry, which was then coated on a PET film via an automatic gap coat. The film was then dried in a vacuum oven at 60° C. for 3 hours to evaporate PGMEA solvent. The QY retention curve is compiled in FIG. 1.

### Comp Ex B

To form QD-silicate composites in situ, the InP/ZnSeS QD solution obtained above was mixed with a mixture of TEOS and 3-mercaptopropylsilane in ethanol at room temperature, and then a catalyst was added to adjust the pH value of the reaction mixture to around 2-4 if the catalyst was an acid, or around 9-11 if the catalyst was a base. A series of catalysts were screened to study their impacts on the emission properties of QDs, including formic acid, acetic acid, p-toluenesulfuric acid, hydrochloric acid, oleic acid, ammonia aqueous solution, triethanolamine, cetylamine, and trimethylamine. In all cases, fluorescence from the obtained QDs was quenched within the first 6 hours of sol gel reaction.

Table 1 gives the emission properties of solid-state QD-Silicate composites of Exs 1 and 3, and the emission properties of a solution QD (Control C). All samples were prepared using the same batch of InP/ZnSeS QDs. As shown in Table 1, the composites of Exs 1 and 3 maintained more than 61% of the initial QYs of QDs (Control C).

TABLE 1

| | Sample | Peak Max (nm) | FWHM (nm) | QY (%) |
|---|---|---|---|---|
| Control C | QD in toluene | 540 | 47 | 30 |
| | solution | | | |
| Ex 1 | QD-Silicate 1 | 547 | 47 | 22.73 |
| | composite | | | |
| Ex 3 | QD-Silicate 3 | 544 | 51 | 18.3 |
| | composite | | | |

Table 2 gives the emission properties of solid-state QD-Silicate composites of Exs 2(b), 2(b)-LE, 5(a) and 5(b) as compared to a solution QD (Control D). All samples were prepared using the same batch of InP/ZnSeS QDs. As shown in Table 2, the composites of the present invention maintained more than 81% of the initial QYs of QDs (Control D).

TABLE 2

| | | Peak Max | FWHM | |
|---|---|---|---|---|
| Sample | Sample | (nm) | (nm) | QY (%) |
| Control D | QD in toluene solution | 561 | 53 | 40.20 |
| Ex 2 (b) | QD-Silicate 2 (b) | 572 | 54 | 34.62 |
| | composite | | | |
| Ex 2 | Ligand Exchanged | 568 | 57 | 36.56 |
| (b)-LE | QD(a)-Silicate 2(b) | | | |
| | composite | | | |
| Ex 5 (a) | QD-Silicate 5 composite | 574 | 55 | 32.49 |
| Ex 5 (b) | Ligand Exchanged | | | |
| | QD(a)-Silicate 5 | 569 | 60 | 33.8 |
| | composite | | | |

Table 3 gives QY retention of films comprising Ligand Exchanged QD(a)-Silicate 2(b) composite and that of the composite of Comp Ex A. All samples were prepared using the same batch of InP/ZnSeS QDs, when both samples were left in open air. As shown in Table 3, the QY retention after 18 days for films comprising Ligand Exchanged QD(a)-Silicate 2(b) composite (Ex 2(b)-LE) was significantly higher than that of Comp Ex A, which indicates that the composite of the present invention has better stability than Comp Ex A.

TABLE 3

| | | QY Retention @ |
|---|---|---|
| | Sample | 18 days |
| Comp Ex A | QD in PMMA film | 34% |
| Ex 2 | Ligand Exchanged | 88% |
| (b)-LE | QD(a)-Silicate 2 (b) | |
| | composite | |

FIG. 1 gives QY retention for QD-Silicate 1 composite in PMMA films (Ex 6) and QD-Silicate 3 composite in PMMA films (Ex 7) as compared to that of Comp Ex A, where all samples were prepared using the same batch of InP/ZnSeS QDs. As shown in FIG. 1, films comprising the composites of Exs 6 and 7 showed higher QY retention than films comprising the composite of Comp Ex A when left in open air, which indicates that Exs 6 and 7 provided better stability.

1. A method of preparing a semiconductor nanocrystal-silicate composite, the method comprising:
(i) providing a sol gel silicate solution, wherein the sol gel silicate is a reaction product of a first silane having the structure of Si(OR¹)₄, wherein R¹ is selected from a substituted or unsubstituted C₁-C₈ alkyl, or a substituted or unsubstituted C₁-C₈ heteroalkyl; and a second silane having the structure of R²SiR³ₙ(OR⁴)₃₋ₙ, wherein n is an integer selected from 0, 1 and 2; R² and R³ are each independently selected from hydrogen, a substituted or unsubstituted C₁-C₃₆ alkyl, a substituted or unsubstituted C₁-C₃₆ heteroalkyl, a substituted or unsubstituted alkenyl, a substituted or unsubstituted alkynyl, a substituted or unsubstituted alkoxy, a substituted or unsubstituted aromatic group, an aliphatic cyclic group, a heterocyclic group, or a heteroaromatic group; and R⁴ is selected from a substituted or unsubstituted C₁-C₈ alkyl, or a substituted or unsubstituted C₁-C₈ heteroalkyl; wherein the sol gel silicate has a number average molecular weight of 500 or more;
(ii) mixing semiconductor nanocrystals with the sol gel silicate solution to form a mixture;
(iii) drying or allowing to dry the mixture to provide the composite; and
(iv) optionally milling the composite.

2. The method of claim 1, wherein the sol gel silicate solution is neutralized to a pH value of from 5 to 9 prior to mixing with the semiconductor nanocrystals.

3. The method of claim 2, wherein the sol gel silicate solution is neutralized by ion exchange resins.

4. The method of claim 1, wherein the first silane is selected from tetramethoxysilane, tetraethoxysilane, tetrabutoxysilane, tetrapropoxysilane, tetrapentyloxysilane, tetrahexyloxysilane, or mixtures thereof.

5. The method of claim 1, wherein the second silane is selected from 1-naphthalytrimethoxysilane, phenyltrimethoxysilane, 3-mercaptopropyltrimethoxysilane, 3-aminopropyltrimethoxysilane, cyclohexyltrimethoxysilane, 3-glycidyloxypropyltrimethoxysi lane, octadecyltrimethoxysilane, or mixtures thereof.

6. The method of claim 1, wherein reaction of the first silane and the second silane is conducted in the presence of a solvent, wherein the solvent is selected from propylene glycol methyl ether acetate, butanol, a mixture of propylene glycol methyl ether acetate and butanol, a mixture of toluene and butanol, a mixture of xylene and butanol, or a mixture of chloroform and butanol.

7. The method of claim 1, wherein the sol gel silicate has a number average molecular weight of from 1,000 to 3,000.

8. The method of claim 1, wherein the semiconductor nanocrystals are selected from a group II-VI compound, a group Ill-V compound, a group I-III-VI compound, a group IV-VI compound, and combinations thereof.

9. The method of claim 1, wherein the semiconductor nanocrystals have a particle size of from 1 to 10 nanometers.

10. The method of claim 1, wherein the molar ratio of the first silane to the second silane is from 95/5 to 50/50.

11. A semiconductor nanocrystal-silicate composite prepared by the method of claim 1.

12. A film comprising a semiconductor nanocrystal-silicate composite of claim 11 and a host material, wherein the composite is dispersed in the host material.

13. The film of claim 12, wherein the host material is selected from polystyrene, polyacrylate acid, a polyacrylate acid salt, an acrylic polymer, polycarbonate, polyolefin, polyvinyl alcohol, polyvinyl chloride, polyurethane, polyamide, polyimide, polyester, polyether, polyvinyl ester, polyvinyl halide, a silicone polymer, an epoxy resin, alkyd, polyacrylonitril, polyvinyl acetal, cellulose acetate butyrate, a siloxane polymer, or mixtures thereof.

14. An electronic device comprising a semiconductor nanocrystal-silicate composite of claim 11.

15. The electronic device of claim 14, wherein the electronic device comprises a light emitting apparatus, wherein the light emitting apparatus comprises a layer comprising the semiconductor nanocrystal-silicate composite and a host material.
